(19) United States
(12) Patent Application Publication
(10) Pub. No.: US 2006/0266193 A1
(43) Pub. Date: Nov. 30, 2006

(54) Combination steel rule die and height adapter

(76) Inventor: Kevin L. Corcoran, Mission Viejo, CA (US)

Correspondence Address: MORLAND C FISCHER, 2030 MAIN ST, SUITE 1050, IRVINE, CA, 92614, US

(21) Appl. No.: 11/139,355

(22) Filed: May 27, 2005

(51) Int. Cl. B26D 1/12

(52) U.S. Cl. 83/669

(57) ABSTRACT

The combination of a conventional steel rule die for cutting shapes in sheet material and a height adapter to be attached to the top of the die to increase the original height (i.e., thickness) of the die. Accordingly, the combination will be sized so as to fit snugly within a gap in a hand operated die press between a pressing force generator and the sheet material to be cut. By virtue of the addition of the height adapter, the die will lie within the gap in close proximity to the force generator so as to receive a pressing force necessary for properly cutting the sheet material into the desired shape. Positioning guidelines are marked on the top of the height adapter to alert the press operator as to the ideal positions of the combination relative to the pressing force generator of the die press.

### BACKGROUND OF THE INVENTION

1. Field of the Invention

This invention relates to the combination of a conventional steel rule die to be used in a hand operated die press so as to cut sheet material that is fed into the press and a height adapter that is affixed to the die to increase the height (i.e., thickness) thereof and thereby enable the die to fit more snugly within the die press so as to lie in close proximity to a pressing force generating means thereof.

2. Background Art

Hand operated die presses are well known for cutting, embossing, stamping, etc. sheet material that is fed into the press. By way of a particular example, a conventional steel rule die having a set of cutting blades is removably inserted into the die press. When no pressing force is generated by the press, the cutting blades are shielded by the die. When a handle, or the like, is manually rotated, the press is adapted to generate a corresponding pressing force. The pressing force is transferred to the die to cause the cutting blades to be exposed in order to cut the sheet material into a shape that is defined by the cutting blades.

The foregoing is accomplished by inserting the steel rule die within a gap between pressing force generating means of the press and the sheet material to be cut. In the event that the die is too short (i.e., small) to fit snugly within the gap, the pressing force may not be adequately transferred from the force generating means to the die to be able to properly cut the sheet material, as desired. In this same regard, if the die is not accurately positioned within the gap to lie below the force generating means of the press, the sheet material may not receive the full pressing force that is necessary for the material to be cut completely.

Thus, what is desirable is an adapter to be affixed to a die to enable the height or thickness of the die to be increased and the position of the die to be selected so that the die will be located within the gap of a die press in order to receive an adequate pressing force from a pressing force generating means for reliably cutting the sheet material that is fed into the press.

### SUMMARY OF THE INVENTION

Disclosed below is the combination of a die (e.g., a steel rule die) and a height adapter affixed to the die to increase the height (i.e., thickness) of the die and thereby enable the die to fit snugly within a hand operated die press. The steel rule die is a conventional die that is known for cutting sheet material to be fed into the die press. The die includes a rigid (i.e., non-compressible) wooden base that carries a set of steel cutting blades. A resilient (i.e., compressible) pad covers the bottom of the wooden base, and the cutting blades extend from the base into the resilient pad. When the steel rule die is not being used in the die press, the cutting blades are shielded by the resilient pad. When the die is located in the die press and a handle thereof is rotated, a corresponding pressing force is generated against the base which compresses the resilient pad and thereby causes the cutting blades to be exposed for cutting the sheet material into a shape that is defined by the configuration of the cutting blades.

In order to ensure that an adequate pressing force is applied to the base to be transferred to the resilient pad lying thereunder so that the pad will be compressed and the cutting blades will be exposed to cut the sheet material, a (e.g., plastic) height adapter is affixed over top the steel rule die so as to form a shell that encloses the base and permits the resilient pad to engage the sheet material to be cut. According to a preferred embodiment, the height adapter is adhesively bonded to the base so as to receive the base at a hollow receptacle therewithin. The height adapter increases the original height (i.e., thickness) of the die in order to create a snug fit for the combination die and height adapter within a gap between the pressing force generating means of the die press and the sheet material to be cut, but without having to alter the press. By virtue of the foregoing, the force generating means will be located in close proximity to the height adapter within the gap of the press so that all of the pushing force generated by the force generating means will be transferred through the base and to the resilient pad lying thereunder so as to compress the pad and cause the cutting blades to be exposed for cutting the sheet material into the desired shape.

In order to ensure that the combination height adapter and steel rule die is properly positioned within the gap of the die press to lie below the pushing force generating means thereof, a set of placement guidelines is marked on the height adapter. According to a preferred embodiment, the placement guidelines are formed as parallel aligned grooves running across the top of the height adapter. The operator positions the combination die and height adapter relative to the force generating means at ideal locations represented by the guidelines so that when the handle of the press is rotated, the die will receive the pushing force needed to completely cut the sheet material.

### BRIEF DESCRIPTION OF THE DRAWINGS

FIG. 1 is an exploded view of a height adapter to be affixed to a conventional steel rule die to increase the original height (i.e., thickness) of the die;

FIG. 2 shows the combination height adapter and steel rule die of FIG. 1 in the assembled configuration;

FIG. 3 illustrates a set of placement guidelines marked across the top of the height adapter of the combination of FIG. 2; and

FIG. 4 shows a hand operated die press with the combination height adapter and steel rule die positioned at an ideal location below a pressing force generating means of the press according to the set of placement guidelines illustrated in FIG. 3.

### DESCRIPTION OF THE PREFERRED EMBODIMENT

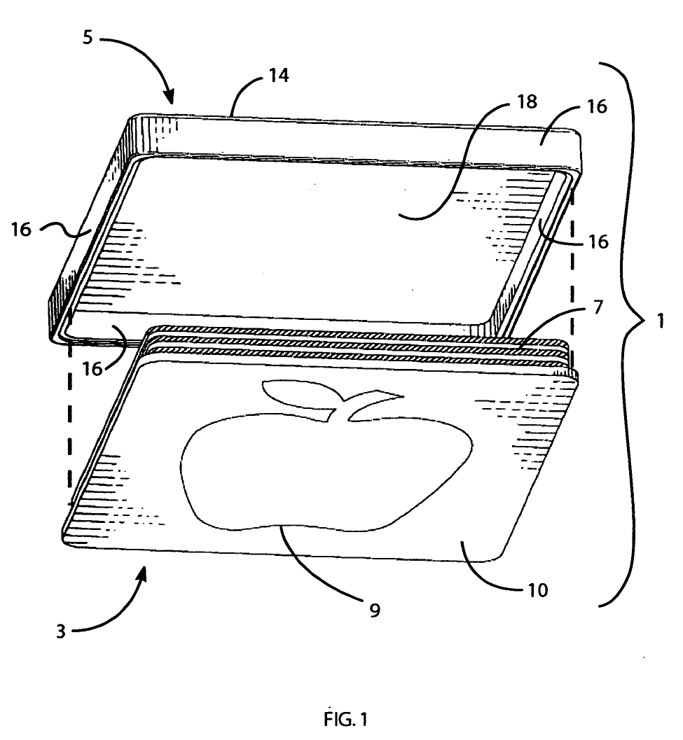

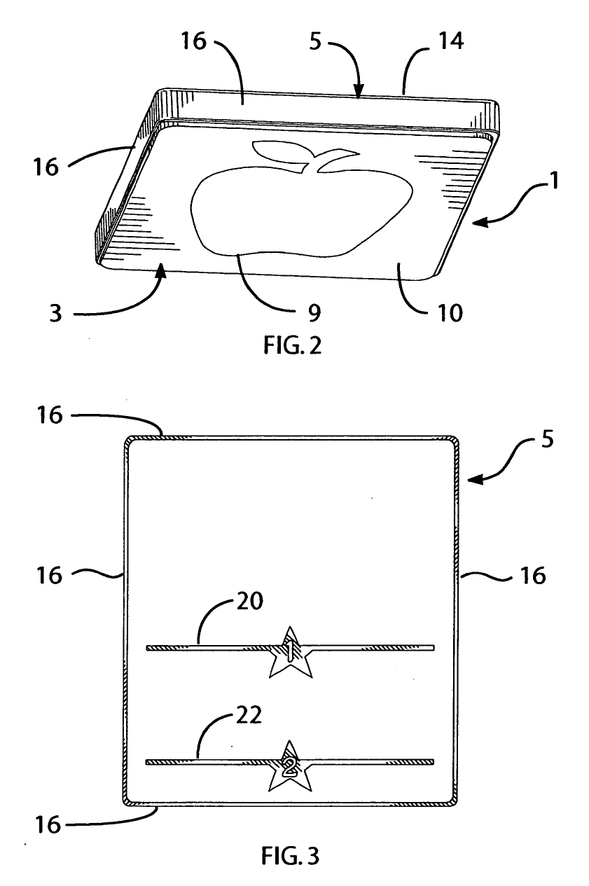

The combination 1 of a steel rule die 3 and a height adapter 5 according to a preferred embodiment of this invention is initially described while referring concurrently to FIGS. 1 and 2 of the drawings. The steel rule die 3 described herein is a commercially available die and, therefore, only a brief description thereof will be provided. Die 3 includes a generally rectangular base 7 that is typically manufactured from a rigid, non-compressible material, such as wood. However, it is also known to make the base 7 from metal or plastic. The base 7 of die 3 carries a set of steel rule cutting blades 9 embedded therein. The set of cutting blades 9 can have any one of a variety of different configurations for cutting a sheet material made from paper, plastic, rubber, and the like, into a corresponding shape, such as that shown in FIGS. 1 and 2 which is representative of an apple.

The wooden base 7 of steel rule die 3 is covered at its bottom by a resilient pad 10. The pad 10 is typically manufactured from foam rubber or any other suitable material which is capable of being compressed under pressure. The steel cutting blades 9 which are embedded in the wooden base 7 extend into the resilient pad 10 which lies below the base 7. When the die 3 is not being used in a die press, the steel cutting blades 9 are shielded by the pad 10. However, when the die 3 is placed in a suitable die press (such as that designated 25 and shown in FIG. 4) and subjected to a pressing force generated by the press, the resilient pad 10 will be compressed against the non-compressible base 7, and the cutting blades 9 will now be exposed to perform a die cutting operation on the sheet material that is fed into the press.

In the event that the steel rule die 3 is not sufficiently high, the pressing force generating means of the press may not be able to closely engage the base 7 in order to impart an adequate pressing force thereagainst by which to cause the resilient pad 10 to be compressed and the cutting blades 9 to be exposed from within the pad 10 to make contact with the sheet material to be cut. Consequently, the design to be shaped in the sheet material by the cutting blades 9 may be improperly cut or not cut at all.

To overcome this problem and ensure that the force generating means of the die press will closely engage the base 7 in order to apply the necessary pressing force thereagainst to enable the resilient pad 10 to be compressed and the sheet material to be properly cut, the aforementioned height adapter 5 is mated to the steel rule die 3. The height adapter 5 has a closed top 14 and four side walls 16 depending downwardly therefrom to establish a hollow interior 18. By way of example only, the top 14 and side walls 16 of height adapter 5 are manufactured from plastic and form a shell to enclose the base 7 of die 3 while leaving the pad 10 at the bottom of base 7 available to contact the sheet material to be cut.

More particularly, the height adapter 5 is sized and shaped in order to receive the base 7 within the hollow interior 18 thereof. In this regard, and according to the preferred embodiment, the height adapter 5 is adhesively bonded to the top of the base 7 of steel rule die 3. A rubber or acrylic adhesive, for example, may be used to affix the height adapter 5 to the die 3 so as to enclose the base 7 and thereby complete the assembly of combination 1 (best shown in FIG. 2). However, it is within the scope of this invention for the height adapter 5 to be detachably connected to the base 7 of die 3 to enable adapters having different heights (i.e., thicknesses) to be mated to the die 3 to achieve combinations having correspondingly different heights to meet the requirements of different die presses without having to alter the press. In this case, the height adapter 5 would be detachably connected to the die 3 by means of a close friction fit with the base 7.

That is to say, with the height adapter 5 attached to the base 7 of the steel rule die 3, the height (i.e., thickness) of the die will be increased above the existing base 7 which is now enclosed by adapter 5. In the assembled combination 1 of FIG. 2, it is desirable that the closed top 14 of height adapter 5 lie directly against the top of the base 7 so that a pressing force generated by the die press and applied to the top 14 will be transmitted from the base 7 to the resilient pad 10 to compress pad 10 against base 7 and thereby leave the shielded cutting blades 9 exposed outwardly from the pad 10 for cutting the sheet material.

Accordingly, it may now be appreciated that the height adapter 5 provides a conventional steel rule die 3 with a taller height or profile in order to better fill the gap that is created between the pressing force generating means of the die press and the sheet material to be fed below the resilient pad 10 to be cut by the blades 9. As indicated above, the combination 1 of height adapter 5 and steel rule die 3 enables a close (i.e., snug) engagement of the pressing force generating means of the press and the die without having to alter the press. Thus, by selecting a combination 1 having a height adapter 5 that provides a particular overall height (i.e., thickness) to match the size of the gap of a particular die press, a sufficient pressing force can be generated against the closed top 14 of height adapter 5 to ensure a uniform and accurate cut in the sheet material by means of the cutting blades 9 of die 3. What is even more, the height adapter 5 functions to protect the die 3 by filling the gap and thereby limiting the thickness of the sheet material to be cut so as not to bend or damage the cutting blades 9 thereof.

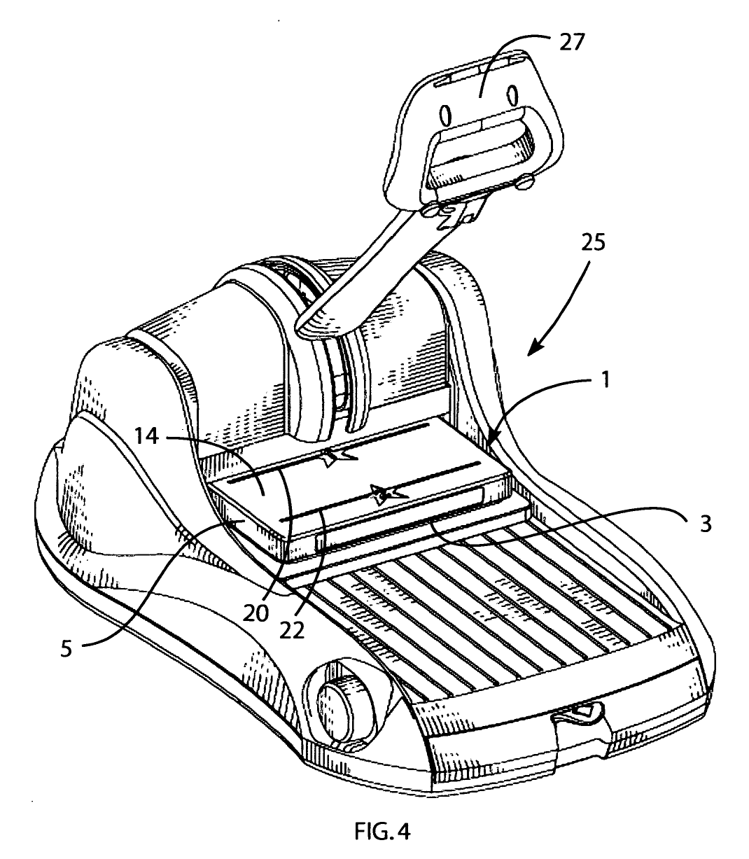

Turning now to FIG. 3 of the drawings, there is shown the closed top 14 of the height adapter 5 which, in the assembled combination 1 of FIG. 2, lies directly above and is affixed to the base 7 of steel rule die 3 to receive a pushing force to be transferred to and compress the resilient pad 10 against the base 7. A series of (e.g., two) parallel aligned placement guidelines 20 and 22 are formed on the top 14 of height adapter 5. Guidelines 20 and 22 are, according to the preferred embodiment, grooves that are machined or etched into the plastic surface of top 14. However, the guidelines 20 and 22 may also be printed or formed as narrow ridges on the top 14.

It may be necessary for the die press to generate a pressing force at more than a single location against the top 14 of the height adapter 5 to enable the die 3 to adequately cut the sheet material. The placement guidelines 20 and 22 quickly and easily identify for the press operator the ideal positions of the die relative to the pressing force generating means of the press in order to receive the force necessary for properly cutting the sheet material into the desired shape. Otherwise, the sheet material could be cut incorrectly or not at all. In the case of FIG. 3, two placement guidelines 20 and 22 are shown to indicate two different locations where the die must be positioned to be properly aligned with the pressing force generating means of the die press. However, any number of guidelines may be formed on the top 14 of adapter 5 depending upon the pressing force that is required to adequately cut the sheet material and/or the specific die press at which the pressing force is generated.

Referring to FIG. 4 of the drawings, one specific hand operated die press 25 is illustrated that is adapted to accommodate within a gap thereof the combination 1 including the height adapter 5 affixed to the original steel rule die 3. The particular hand operated die press 25 shown in FIG. 4 is a commercially available press such as that manufactured by Ellison Educational Equipment, Inc. of Lake Forest, Calif. Die press 25 includes a handle 27 that is manipulated (i.e., rotated) to cause a corresponding pressing force to be applied against the top 14 of height adapter 5. As has been described above, the combination 1 of height adapter 5 and die 3 shown in FIG. 3 should be ideally positioned at two different locations in the press 25 (represented respectively by the two placement guidelines 20 and 22 marked on the top 14 of height adapter 5) in order to receive sufficient force from pressing force generating means of the press to adequately cut the sheet material into the desired shape. In FIG. 4, the combination 1 is presently shown in the press 25 at the first position below the force generating means in alignment with the first placement guideline 20. Following a rotation of handle 27, the combination 1 is displaced so as to be positioned below the force generating means as indicated by the second placement guideline 22. In both positions, the pressing force generating means will be located in close proximity to the top 14 of height adapter 5 so that the pressing force will be reliably transferred through adapter 5 and to the die 3 thereunder.

I claim:

1. In combination:
a die adapted to be positioned in a die receiving space in a die press to receive a force generated by the die press and thereby impart a corresponding force to a sheet material that is fed into the die press, said die having a first height; and
a height adapter attached over said die to increase the first height of said die so that said die makes a snug fit within the die receiving space of the die press.

2. The combination recited in claim 1, wherein said die is a steel rule die having steel cutting blades to cut the sheet material in response to the force generated by the die press.

3. The combination recited in claim 1, wherein said height adapter is affixed to said die.

4. The combination recited in claim 1, wherein said height adapter is manufactured from plastic.

5. The combination recited in claim 1, wherein said height adapter extends across the top of and encloses at least some of said die to increase the first height thereof.

6. The combination recited in claim 1, wherein said height adapter has a set of position guidelines formed thereon by which to indicate corresponding positions of said die within the die receiving space of the die press to receive the force generated by the die press.

7. The combination recited in claim 6, wherein said set of guidelines are grooves formed on said height adapter.

8. In combination:
a die press having a force generating means and a die receiving space below said force generating means within which to receive a die;
a die to be located in the die receiving space of said die press to receive a force generated by said force generating means and thereby impart a corresponding force to a sheet material to be fed into said die press, said die having a first height; and
a height adapter attached to said die in order to increase the first height of said die so that said die makes a snug fit within the die receiving space of said die press to lie in close proximity to said force generating means thereof.

9. The combination recited in claim 8, wherein said height adapter extends across the top of and encloses at least some of said die to increase the first height thereof.

10. The combination recited in claim 8, wherein said height adapter has a set of position guidelines formed on the top thereof by which to indicate corresponding positions of said die within the die receiving space of said die press to receive the force generated by said force generating means of said die press.

11. The combination recited in claim 8, wherein said height adapter is detachably connected to said die so that different height adapters having correspondingly different heights can be selectively attached to said die to fill the die receiving space of said die press.
